(19) United States
(12) Patent Application Publication
(10) Pub. No.: US 2026/0166966 A1
(43) Pub. Date: Jun. 18, 2026

(54) Internal Combustion Engine Assembly and Motor Vehicle

(71) Applicant: MAHLE International GmbH, Stuttgart (DE)

(72) Inventor: Thorsten Möllert, Stuttgart (DE)

(21) Appl. No.: 19/421,635

(22) Filed: Dec. 16, 2025

(30) Foreign Application Priority Data
Dec. 17, 2024 (DE) 102024138371.2

(51) Int. Cl. B60H 1/32; F02B 63/06

(52) U.S. Cl. CPC B60H 1/32284; F02B 63/06

(57) ABSTRACT

An internal combustion engine assembly, specifically for a motor vehicle is provided. The internal combustion engine assembly has an internal combustion engine for powering the motor vehicle. The internal combustion engine assembly also has a thermal management module that contains a refrigerant circuit in which a first thermal fluid can circulate, a first heat exchanger, and second heat exchanger, in both of which the first thermal fluid is coupled for heat exchange to at least a second thermal fluid in the refrigerant circuit. The thermal management module is attached to the internal combustion engine.

### CROSS-REFERENCE TO RELATED APPLICATIONS

This application claims priority from German Patent Application No. 102024138371.2, filed on Dec. 17, 2024, the entirety of which is hereby incorporated by reference herein.

The present invention relates to an internal combustion engine assembly for a motor vehicle and a motor vehicle that has such an internal combustion engine assembly.

In motor vehicles with internal combustion engines, a refrigerant compressor for the vehicle's air conditioner is usually attached directly to the internal combustion engine.

It may be assumed, however, that conventional refrigerants may no longer be used for legal reasons. Moreover, refrigerant compressors connected to these conventional internal combustion engines only function when the engine is running.

One of the objects of the present invention is to create a better design for an internal combustion engine with which the above disadvantages are at least partially, ideally entirely, resolved.

This is achieved with the subject matter of the independent Numbered Paragraph. Preferred embodiments are the subject matter of the dependent Numbered Paragraphs.

The fundamental concept of the invention is to therefore provide a thermal management module that has a refrigerant circuit with at least two heat exchangers, instead of a refrigerant compressor, on an internal combustion engine for a motor vehicle, such as that already used in modern electric vehicles for regulating the temperatures of various components therein.

This thermal management module has a refrigerant circuit coupled to at least one temperature control circuit in such a way that their fluids are kept separate. The temperatures of the components of the vehicle, as well as the vehicle interior, that are to be regulated by the thermal management module, are controlled indirectly by the temperature control circuit, rather than directly by the refrigerant circuit. The refrigerant circuit is only used to heat or cool the temperature control circuit.

The refrigerant circuit, in which a first thermal fluid circulates, i.e. a refrigerant, as well as the temperature control circuit, in which a second thermal fluid circulates, i.e. a temperature regulating fluid, both pass through at least two heat exchangers that are used for this. Consequently, the second fluid can be heated by the first. The second fluid can also be cooled by transferring heat to the first. Because the refrigerant circuit, and therefore the refrigerant circulating therein, i.e. the first thermal fluid, has no thermal contact with the parts of the vehicle components that are to be heated or cooled, and also does not pass through the vehicle interior, a conventional refrigerant, such as the aforementioned propane, can still be used with the invention.

It is therefore proposed to attach the thermal management module directly to the internal combustion engine, thus forming an internal combustion engine assembly. Consequently, the above advantages of a thermal management module for regulating the temperature of a vehicle's interior, as well as various components, can also be obtained for a vehicle with an internal combustion engine.

In detail, the internal combustion engine assembly obtained with the invention, specifically for a motor vehicle, contains an internal combustion engine for powering the vehicle. This assembly also contains a thermal management module. The thermal management module has a refrigerant circuit through which a first thermal fluid circulates when the internal combustion engine is running, or the thermal management module is in use. The thermal management module also contains first and second heat exchangers, and potentially other heat exchangers. These heat exchangers transfer heat between the first thermal fluid and at least a second thermal fluid circulating in at least one temperature control circuit.

There can also be a compressor in the refrigerant circuit for the first thermal fluid, as well as an expander.

The thermal management module can contain a reservoir for the first thermal fluid, which has numerous ports for the first thermal fluid, and preferably for the second. There can also be a valve on the thermal management module for regulating the flow of the first and/or second thermal fluid therethrough, and at least one sensor for measuring the pressure or temperature of the first and/or second thermal fluid. This thermal management module can also contain a heat exchanger with which the first and second thermal fluids can exchange heat. In accordance with the invention, the thermal management module is attached directly to the internal combustion engine.

The thermal management module is preferably releasably attached to the internal combustion engine. This makes it easy to be installed thereon. Moreover, it can be easily removed if it requires any repairs or needs to be replace.

Ideally, the thermal management module is attached to a flange on the internal combustion engine. Preferably, this flange is designed for attaching a conventional air conditioner compressor to the internal combustion engine. Consequently, the thermal management module can replace the air conditioner compressor.

Threaded fasteners can be used to attach the thermal management module to the internal combustion engine, or the flange thereon. This allows the thermal management module to be removed, while ensuring that it is otherwise securely attached to the internal combustion engine.

The thermal management module is preferably attached to a flange on the engine block. This flange can be an integral part of the engine block. This has significant cost advantages.

The thermal management module ideally has at least two, preferably more, electrical components for regulating the temperature of at least one component in the vehicle, and an electric control unit for at least one of these electrical components. Consequently, the thermal management module can be readily connected to these components and the control unit as a module on the internal combustion engine.

The thermal management module can have a mount to which the two electrical components are attached. Ideally, the thermal management module can be attached to the internal combustion engine, or the flange thereon, with this mount. This also simplifies the attachment of the thermal management module to the internal combustion engine.

The first thermal fluid is preferably propane, specifically R290. Because the refrigerant circuit in the internal combustion engine assembly obtained with the invention is no longer used directly to regulate the temperature of the vehicle interior or other components, which instead are cooled indirectly by a temperature control circuit, propane, which has numerous advantages, can continue to be used as a refrigerant, as is the case with conventional internal combustion engines that have air conditioner compressors.

The invention also relates to a motor vehicle that has the above internal combustion engine assembly, such that the advantages specified above for the internal combustion engine assembly also apply to the motor vehicle obtained with the invention.

The temperature of at least one component in this motor vehicle can be regulated by the thermal management module.

Preferably, the temperature of the vehicle interior can be regulated by the thermal management module.

The thermal management module contains at least one temperature control circuit through which the second thermal fluid can circulate for regulating the temperature of the at least one component and/or the vehicle interior. The temperature control circuit, containing the second thermal fluid, and the refrigerant circuit, containing the first thermal fluid, both pass through each heat exchanger. The first heat exchanger functions as an evaporator, in which the first thermal fluid is vaporized by heat. The heat necessary for this is drawn from the second thermal fluid, thus cooling it.

The second heat exchanger heats the at least one second thermal fluid with the first. The second heat exchanger therefore functions as a condenser in which the first thermal fluid is condensed by discharging heat to the second.

Ideally, there is exactly one temperature control circuit through which the second thermal fluid can flow, in which both the first and second heat exchangers are located. Consequently, the second thermal fluid can be cooled by the first heat exchanger, and heated by the second heat exchanger.

There can also be two or more separate temperature control circuits, which can be thermally connected to the refrigerant circuit by a heat exchanger.

Further important features and advantages of the invention can be derived from the dependent Numbered Paragraphs, drawings, and descriptions of the drawings.

It is understood that the features specified above and explained below can be used not only in the given combinations, but also in other combinations or in and of themselves, without abandoning the scope of protection for the present invention.

Preferred exemplary embodiments of the invention are shown in the drawings and shall be explained in greater detail below, in which the same reference symbols refer to the same, similar, or functionally identical components.

Therein, schematically:

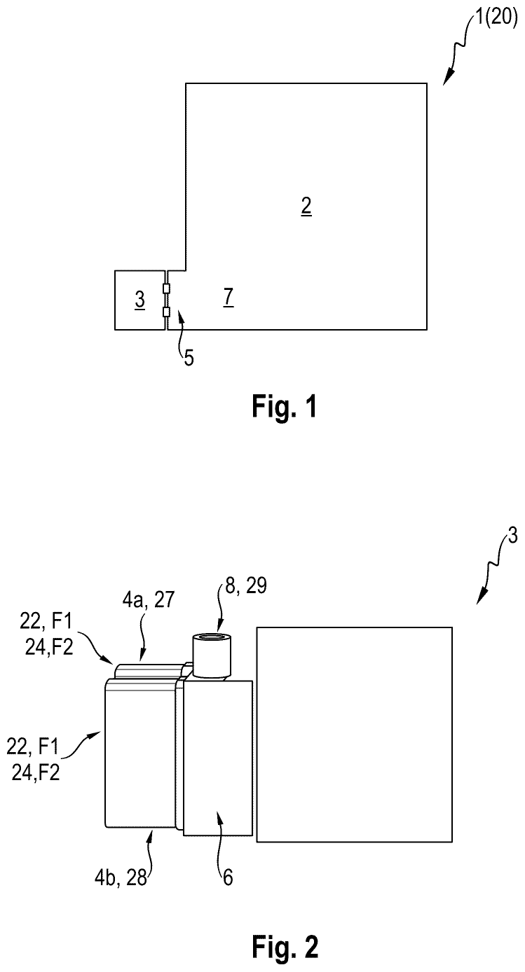

FIG. 1 an example of the internal combustion engine assembly obtained with the invention, in a perspective view,

FIG. 2 shows a simple example of how the internal combustion engine assembly obtained with the invention can be used in a motor vehicle, and

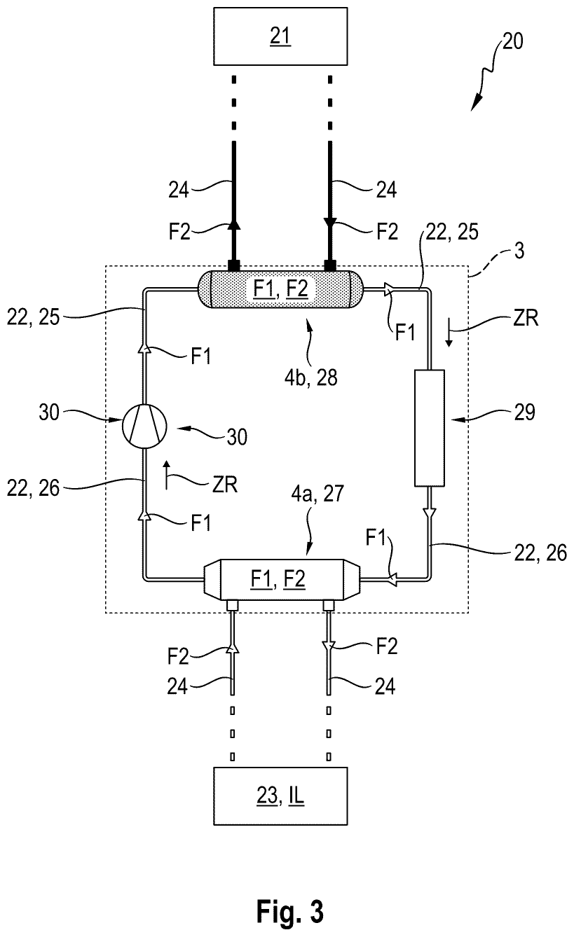

FIG. 3 shows a simple example of how the internal combustion engine assembly can be used as part of the vehicle 20 obtained with the invention.

FIG. 1 illustrates the internal combustion engine assembly 1 obtained with the invention in a perspective view, for a motor vehicle 20, which is not shown in greater detail.

The internal combustion engine assembly 1 contains a conventional internal combustion engine 2 for a motor vehicle 20. The internal combustion engine 2 can run on diesel, gasoline, or some other fuel. The internal combustion engine 2 can also be part of a hybrid drivetrain.

The internal combustion engine 2 has a flange 5 formed as an integral part of the engine block 7. The flange 5 can be used for attaching a conventional compressor (not shown) for the air conditioner in a motor vehicle. The internal combustion engine assembly 1 obtained with the present invention, however, does not have an air conditioner compressor on the internal combustion engine 2.

Instead of an air conditioner compressor, the internal combustion engine assembly 1 shown in FIG. 1 has a thermal management module 3 for regulating the temperature of at least one component (not shown) in the vehicle 20. The thermal management module 3 is attached to the flange 5 on the internal combustion engine 2, and therefore connected to the engine block 7.

The thermal management module 3 is shown separately in FIG. 2, in a perspective view. The thermal management module 3 has a refrigerant circuit 22, not shown in detail in FIGS. 1 and 2 (see FIG. 3), through which a first thermal fluid F1 can circulate. The thermal management module 3 also has a first heat exchanger 4a and second heat exchanger 4b, both of which can be formed by stacked plates. Both heat exchangers 4a, 4b couple the first thermal fluid F1 with a second thermal fluid F2 in the refrigerant circuit for heat exchange, while keeping them separate from one another. The second thermal fluid can circulate in a temperature control circuit 24 (not shown in FIG. 2, see FIG. 3), which also passes separately through both heat exchangers 4a, 4b, such that the refrigerant circuit 22 and the temperature control circuit 24, and therefore the two thermal fluids F1, F2 are coupled to one another in the heat exchangers 4a, 4b.

The thermal management module 3 can contain a reservoir 6 with numerous ports, through which at least the first thermal fluid F1 can flow, and which is connected to the heat exchangers 4a, 4b. This reservoir 6 can be part of the refrigerant circuit 22. The thermal management module 3 can also contain electrical components 8, e.g. an expander 29 in the form of an expansion valve. Other electrical components 8 can include sensors (not shown) for measuring the pressure or temperature of the first thermal fluid F1 as it flows through the reservoir 10 in the thermal management module 3. The thermal management module 3 can also have an electric control unit 9 for some or all of the electrical components 8.

The thermal management module 3 can also have a mount (not shown) for these electrical components 8 and the control unit 9. The thermal management module 3 is preferably attached in a releasable manner to the internal combustion engine 2. This connection can be obtained with one or more threaded fasteners (not shown).

FIG. 3 shows a simple example of how the internal combustion engine assembly 1 can be used as part of a motor vehicle 20 obtained with the invention. The motor vehicle 20 has an interior 23, the temperature of which can be regulated by the thermal management module 3 in the internal combustion engine assembly 1, and at least one component 21, the temperature of which can also be regulated by the thermal management module 3. This component 21 can be a battery or power electronics in the motor vehicle 20.

The thermal management module 3 in FIG. 3 contains a refrigerant circuit 22 through which the first thermal fluid F1, functioning as a refrigerant, circulates when in use. The motor vehicle 20 also contains a closed temperature control circuit 24, in which the second thermal fluid F2 circulates when in use to regulate the temperature of the vehicle interior 23 and the component(s) 21 of the vehicle 20. Only part of the temperature control circuit 24 is shown in FIG. 3.

The first and second heat exchangers 4a, 4b couple the first thermal fluid F1 with the second thermal fluid F2 such that they can exchange heat between the refrigerant circuit 22 and the temperature control circuit 24.

The first heat exchanger 4a is a “chiller,” i.e. an evaporator 27, for cooling the second thermal fluid F2 with the first thermal fluid F1. The second heat exchanger 4b is a so-called “ICond”, i.e. a condenser 28 for heating the second thermal fluid F2 by transferring heat thereto from the first thermal fluid F1.

In the direction ZR in which the first thermal fluid F1 flows in the refrigerant circuit 22, there is a compressor 30 for the first thermal fluid F1 downstream of the first heat exchanger 4a. The second heat exchanger 4b is downstream of the compressor 30 in this direction ZR in the refrigerant circuit 22, and there is an expander 29 for the first thermal fluid F1 downstream of the second heat exchanger 4b. The first heat exchanger 4a is then downstream of the expander 29, thus closing the refrigerant circuit 22.

The compressor 30 and the expander ZR divide the refrigerant circuit 22 into a high pressure section 25 and a low pressure section 26. The temperature control circuit 24 can be thermally coupled to the vehicle interior 23, or the air IL therein, by heat exchangers (not shown), to heat this air IL in the interior 23 with the second thermal fluid F2, and the interior 23 can also be cooled by transferring heat from this air IL to the second thermal fluid F2.

The vehicle components 21 can also be thermally coupled to the second thermal fluid F2 circulating in the temperature control circuit 24 to heat them by transferring thereto from the second thermal fluid F2, or cool them by transferring heat therefrom to the second thermal fluid 2.

There is only one temperature control circuit 24 through which the second thermal fluid F2 can flow in the motor vehicle 20 shown in FIG. 3, only part of which is shown therein.

In other versions of the invention, there can be two or more separate temperature control circuits 24 for the vehicle interior 23 and various components 21. These temperature control circuits 24 could also be connected to one another.

The relevant person skilled in the art is aware of various designs that can be selected from for specific applications.

All of the embodiments belonging to the present invention have in common that the temperature control of the vehicle interior 23, or the components 21, is not obtained directly by the refrigerant circuit 22, but instead takes place indirectly through the temperature control circuit 24. In other words, the refrigerant circuit 22 is not thermally coupled directly to the components 21 or the vehicle interior 23. Consequently, propane can be used as the refrigerant in the refrigerant circuit 22.

The specification can be readily understood with reference to the following Numbered Paragraphs:
Numbered Paragraph 1. An internal combustion engine assembly (1), specifically for a motor vehicle, which has an internal combustion engine (2) for powering the motor vehicle, and a thermal management module (3) that contains a refrigerant circuit (22) in which a first thermal fluid (F1) can circulate, a first heat exchanger (4a), and second heat exchanger (4b), in both of which the first thermal fluid (F1) is coupled for heat exchange to at least a second thermal fluid (F2) in the refrigerant circuit, wherein the thermal management module (3) is attached to the internal combustion engine (2).
Numbered Paragraph 2. The internal combustion engine assembly according to Numbered Paragraph 1, characterized in that the thermal management module (3) is releasably attached to the internal combustion engine (2).
Numbered Paragraph 3. The internal combustion engine assembly according to Numbered Paragraph 1 or 2, characterized in that the thermal management module (3) is attached to a flange (5) on the internal combustion engine (2).
Numbered Paragraph 4. The internal combustion engine assembly according to Numbered Paragraph 3, characterized in that the flange (5) is designed for attaching an air conditioner compressor.
Numbered Paragraph 5. The internal combustion engine assembly according to any of the preceding Numbered Paragraphs, characterized in that the thermal management module (3) is releasably attached to the internal combustion engine (2) or flange (5) with at least one threaded fastener.
Numbered Paragraph 6. The internal combustion engine assembly according to any of the preceding Numbered Paragraphs, characterized in that the thermal management module (3) is attached to an engine block (7) for the internal combustion engine (2), and the flange (5) is preferably an integral part of the engine block (7).
Numbered Paragraph 7. The internal combustion engine assembly according to any of the preceding Numbered Paragraphs, characterized in that the thermal management module (3) has at least two electrical components (8) for regulating the temperature of at least one component in a vehicle, and an electric control unit (9) for the at least two electrical components (8).
Numbered Paragraph 8. The internal combustion engine assembly according to any of the preceding Numbered Paragraphs, characterized in that the thermal management module (2) has a mount to which at least two electrical (8) are attached.
Numbered Paragraph 9. The internal combustion engine assembly according to any of the preceding Numbered Paragraphs, characterized in that the first thermal fluid (F1) is propane, specifically R290.
Numbered Paragraph 10. A motor vehicle (20) that has an internal combustion engine assembly (1) according to any of the preceding Numbered Paragraphs, at least one component (21), the temperature of which can be regulated by the thermal management module (3), wherein the vehicle (20) preferably has an interior (23), the temperature of which can be regulated by the thermal management module (3), and at least one temperature control circuit (24) in which the second thermal fluid (F2) can circulate to regulate the temperature of the vehicle interior (23) and/or the at least one component (21), wherein the temperature control circuit (24) with the second thermal fluid (F2) is located in the first and/or second heat exchanger (4a, 4b).
Numbered Paragraph 11. The motor vehicle according to Numbered Paragraph 10, characterized in that the first heat exchanger (4a) is designed to cool the at least one second thermal fluid (F2) with the first thermal fluid (F1).
Numbered Paragraph 12. The motor vehicle according to Numbered Paragraph 10 or 11, characterized in that the second heat exchanger (4b) is designed to heat the at least one second thermal fluid (F2) with the first thermal fluid (F1).
Numbered Paragraph 13. The motor vehicle according to any of the Numbered Paragraphs 10 to 12, characterized in that there is exactly one temperature control circuit (24) through which the second thermal fluid (F2) can flow, in which both the first and second heat exchangers (4a, 4b) are located.
Numbered Paragraph 14. The motor vehicle according to any of the Numbered Paragraphs 10 to 12, characterized in that there are at least two temperature control circuits (24).

### List of Reference Symbols

1 internal combustion engine assembly
2 internal combustion engine
3 thermal management module
4 heat exchanger
5 flange
6 reservoir
7 engine block
8 electrical component
9 control unit
20 motor vehicle
21 vehicle component
22 refrigerant circuit
23 vehicle interior
24 temperature control circuit
25 high pressure section
26 low pressure section
27 evaporator
28 condenser
29 expander
30 compressor
F1 first thermal fluid
F2 second thermal fluid
IL interior air
ZR circulating direction

1-14. (canceled)

15. An internal combustion engine assembly (1) for a motor vehicle, comprising: an internal combustion engine (2) configured for powering the motor vehicle, and a thermal management module (3) that contains a refrigerant circuit (22) in which a first thermal fluid (F1) is configured to circulate, a first heat exchanger (4a), and second heat exchanger (4b), in both of which the first thermal fluid (F1) is coupled for heat exchange to at least a second thermal fluid (F2) in the refrigerant circuit, wherein the thermal management module (3) is attached to the internal combustion engine (2).

16. The internal combustion engine assembly according to claim 15, wherein the thermal management module (3) is releasably attached to the internal combustion engine (2).

17. The internal combustion engine assembly according to claim 15, wherein the thermal management module (3) is attached to a flange (5) on the internal combustion engine (2).

18. The internal combustion engine assembly according to claim 17, wherein the flange (5) is configured for attaching an air conditioner compressor.

19. The internal combustion engine assembly according to claim 15, wherein the thermal management module (3) is releasably attached to the internal combustion engine (2) or flange (5) with at least one threaded fastener.

20. The internal combustion engine assembly according to claim 15, wherein the thermal management module (3) is attached to an engine block (7) for the internal combustion engine (2), and the flange (5) is an integral part of the engine block (7).

21. The internal combustion engine assembly according to claim 15, wherein the thermal management module (3) comprises at least two electrical components (8) that are configured for regulating the temperature of at least one component in a vehicle, and an electric control unit (9) configured to cause operation of the at least two electrical components (8).

22. The internal combustion engine assembly according to claim 15, wherein the thermal management module (2) comprises a mount to which at least two electrical (8) are attached.

23. The internal combustion engine assembly according to claim 15, wherein the first thermal fluid (F1) is R290.

24. A motor vehicle (20) that has an internal combustion engine assembly (1) according to claim 15, further comprising at least one component (21), the temperature of which can be regulated by the thermal management module (3), wherein the vehicle (20) comprises an interior (23), the temperature of which can be regulated by the thermal management module (3), and at least one temperature control circuit (24) in which the second thermal fluid (F2) is configured to circulate to regulate the temperature of the vehicle interior (23) and/or the at least one component (21), wherein the temperature control circuit (24) with the second thermal fluid (F2) is located in the first and/or second heat exchanger (4a, 4b).

25. The motor vehicle according to claim 24, wherein the first heat exchanger (4a) is designed to cool the at least one second thermal fluid (F2) with the first thermal fluid (F1).

26. The motor vehicle according to claim 24 wherein the second heat exchanger (4b) is configured to heat the at least one second thermal fluid (F2) with the first thermal fluid (F1).

27. The motor vehicle according to claim 24, further comprising exactly one temperature control circuit (24) through which the second thermal fluid (F2) can flow, in which both the first and second heat exchangers (4a, 4b) are located.

28. The motor vehicle according to claim 24, further comprising at least two temperature control circuits (24).
